(19) United States
(12) Patent Application Publication
(10) Pub. No.: US 2013/0093589 A1
(43) Pub. Date: Apr. 18, 2013

(54) RESPONDER ACCOUNTABILITY PROXIMITY WIRELESS ALERT SYSTEM AND METHOD

(71) Applicant: Vic Hsiao, Mission Viejo, CA (US)

(72) Inventor: Vic Hsiao, Mission Viejo, CA (US)

(73) Assignee: KNOWLEDGE ACCESS, INC.

(21) Appl. No.: 13/276,270

(22) Filed: Oct. 18, 2011

(51) Int. Cl. G08B 1/08

(52) U.S. Cl. 340/539.13

(57) ABSTRACT

A wireless proximity system for responders to an emergency is presented. The wireless proximity system includes a command post comprising a command post communication link configured to transmit and receive information, a responder unit attached to a responder and comprising a unique electronic identifier and a ranging radio, the responder unit configured to receive a ranging query and transmit information including a unique electronic identifier via the ranging radio, and a leader unit.

### BACKGROUND OF THE INVENTION

1. Field of the Invention

The present invention relates to a system and method for position tracking, more particularly, to the use of a position tracking system with a Responder team operation.

2. Discussion of the Related Art

Responders to an emergency or a disaster may include firefighters, policemen, medical technicians, doctors, or other such personnel. In the following description, personnel that respond to incidents, such as firemen, police officers, and medical personnel will sometimes be referred to as Responders.

In an indoor incident, Responders have to deal with a number of unknown situations, such as building structure, disaster type, disaster intensity, number of Responders needed, resources needed, or other such situations. In order to obtain maximum effectiveness, the Commander of an incident scene requires accurate reporting of the status of all resources, including Responders.

When Responders arrive at the scene of an incident, such as a structural fire, the Responders often enter a structure as a team and follow a plan maintained by an incident Commander located away from the scene. According to the National Fire Protection Association (NFPA) Standard 1500, the incident Commander and the Responders are accountable for ensuring that all team members are safe. Specifically, the NFPA Standard 1500 states that the “incident commander shall maintain an awareness of the location and function of all companies or crews at the scene of the incident and company officers shall maintain an ongoing awareness of the location and condition of all company members.”

Generally, for status reporting, Responders are provided with a talk-radio to communicate with other personnel or a command post. The talk-radios may not be effective at all times due to, for example, structural blockages, debris, electronic interference, or physical interference. In the event of a fire, a Responder may be exposed to, such things as, extreme heat, water, power lines, or hazardous materials. Under such an environment, it is very easy for a Responder to be set apart from his peers or to lose his sense of direction.

With limited resources at hand, a Responder may not have the time required to report his location when support is needed. Additionally, the incident Commander often has little to no information as to the whereabouts of the Responders within the structure. This situation puts Responders in danger since their location and vital statistics may be unavailable to the incident Commander.

Thus a need exists for a system to monitor the proximity location and vital statistics of Responders, to virtually connect company personnel with their team leader and the incident Commander, and to provide alerts when team integrity or a Responder's vital statistics are compromised.

Numerous systems exist to provide tracking for Responders. These systems include, for example, “First Responder Positioning Apparatus” (U.S. 2007/0126623), “RF/Acoustic Person Locator System” (U.S. 2007/0205886), and “Precision Location Methods and Systems” (U.S. 2001/0027739).

The aforementioned tracking systems typically include a navigation system, such as Global Positioning System (GPS), multiple fixed reference stations attached to the incident scene, multiple fixed reference stations installed on vehicles or public infrastructure, and complex electronic circuitry carried by Responders. The advent of the GPS system has made it possible for a geographic location to be determined within a sub-meter.

While GPS allows for a Responder's position to be rapidly and accurately determined, GPS requires a high performance antenna. Carrying a high performance antenna is an additional burden for a Responder. Moreover, without a high performance antenna, a GPS signal is not always available or reliable when a Responder is indoors.

Triangulation algorithms and multi-lateration algorithms for determining a position of an object have been well developed and widely employed. These algorithms use a known position of multiple reference points and utilize the distance from the reference point to the object in order to triangulate the object's position. Triangulation algorithms require at least two reference points. For a more accurate triangulation in a three-dimensional (3D) space, the reference points should be positioned around the object and be as far apart as possible.

Triangulation algorithms or multi-lateration algorithms are typically used in location systems requiring multiple fixed reference stations. In many configurations, location systems requiring multiple fixed reference stations attached to the incident scene are not useful or effective for an indoor incident. Specifically, the time required to install and initialize the fixed reference stations is not suitable for a rapid deployment environment such as an emergency or disaster. Moreover, fixed reference stations may not be installed to form an optimal topology to produce the best results for a Responder's position.

For the reasons mentioned above, multiple fixed reference stations installed on vehicles or public infrastructures are also not useful or effective. In addition, the dynamics of an emergency or disaster may cause the installed fixed reference stations to be damaged or rendered ineffective as a result of structural damage from the incident.

Additionally, location systems requiring complex electronic circuitry are impractical. Systems with complex electronic circuitry have higher electric power requirements, generate more heat, are heavier in weight, and larger in size. Responders may be burdened by the increased weight and size of the tracking system equipment.

A critical aspect of accountability for Responders to an incident is to keep all Responders within the vicinity of the Responder Group Leader and to make each individual Responder's vital conditions known to the incident Commander.

Thus, it is desirable for the Responder Accountability Proximity Wireless Alert System (“RAPAWS”) to provide the incident Commander with the proximity location of each individual Responder in relation to the Responder Group Leader and with vital statistics of Responders, including the Responder Group Leader, without requiring deployment of reference points.

The RAPWAS should include a Responder device that can be easily attached to a Responder in the field and a command post subsystem that can derive a proximity location of each individual Responder, create a three-dimensional (3D) Responder proximity map, display the 3D Responder proximity map, and generate an alert upon detection of a proximity exception or a vital statistic exception.

Accordingly, the proposed system and method accurately and quickly provides the status and condition of all resources, including Responders. The proposed system also facilitates effective Responder team operation and further facilitates support to a Responder as needed at an incident scene.

### SUMMARY

Features and advantages of the invention will be set forth in the description which follows. The objectives and other advantages of the invention will be realized and attained by the structure particularly pointed out in the written description and claims hereof as well as the appended drawings.

According to an embodiment, a wireless proximity system for responders to an emergency is presented. The wireless proximity system includes a command post comprising a command post communication link configured to transmit and receive information, a responder unit attached to a responder and comprising a unique electronic identifier and a ranging radio, the responder unit configured to receive a ranging query and transmit information including a unique electronic identifier via the ranging radio, a leader unit including a unique electronic identifier, a first antenna configured to communicate with the ranging radio of the responder unit of each responder, a second antenna configured to communicate with the command post communication link, a navigation module for determining a current position of the leader unit, and a ranging processor configured to control the navigation module, to control transmission of the ranging query to the responder unit, and to decode the information received from the responder unit.

According to one feature the leader unit further includes a memory unit and a housing unit configured to house the ranging processor, the memory unit, the first antenna, the second antenna, and the navigation module. Furthermore, the leader unit further may further include a leader/master mode ranging processor configured determine a round-trip-air-time between the ranging query sent to the responder unit and the information received from the responder unit, wherein the ranging processor decodes the unique electronic identifier in the information received from the responder unit, a message reporting processor coupled to the navigation module and the ranging processor, the message reporting processor configured to process information to be reported to the command post. Additionally, the leader/master mode ranging processor is may be further configured to register a first navigation time from the navigation module, send a ranging query to the ranging processor for acquiring the unique electronic identifier, receive the unique electronic identifier from the ranging processor, register a second navigation time from the navigation module, measure the round-trip-air-time by subtracting the first navigation time from the second navigation time, and provide the second navigation time, the received unique electronic identifier, and the measured round-trip-air-time to the message reporting processor. Moreover, the message reporting processor may be further configured to generate a leader unit reporting message for output via the second antenna.

According to another feature, the leader unit reporting message includes a current system time, the unique electronic identifier of the leader unit, a responder identification, the current position of the leader unit, a motion indication, the unique electronic identifier received from the responder unit, and the determined round-trip-air-time.

According to yet another feature, the command post further includes a central processing unit, a memory unit comprising a leader unit message database and a responder proximity database, a responder proximity processor configured to determine a proximity location of the responder unit using information from at least one data record of the leader unit message database and to store the determined proximity location of the responder unit in a responder data record associated with the responder proximity database, a personnel vital signs monitoring processor configured to process vital sign sensor data, a responder proximity map processor for generating a three-dimensional (3D) proximity map of the responder unit using the responder data record associated with the responder proximity database, a user interface for displaying the 3D proximity map, and a communication processor for controlling the receipt and transmission of information via the command post communication link. Furthermore, the leader unit message database includes at least one data record for each message received from the leader unit via the communication link of the command post, wherein each of the at least one data record includes a time a message was reported, the unique electronic identifier of the leader unit, the current position of the leader unit, the unique electronic identifier in the information received from the responder unit, and a round-trip-air-time.

According to still yet another feature, the responder data record associated with the responder proximity database includes a time when the responder data record was created, the unique electronic identifier of the responder unit, a name of the responder, and the proximity location of the responder.

According to another feature, the memory unit further includes at least a pre-defined responder distance threshold or a pre-defined responder vital signs threshold for use by the responder proximity processor. Furthermore, the responder proximity processor is further configured to query the at least one data record of the leader unit message database, determine the proximity location of the responder by executing a triangulation algorithm, forward the vital sign sensor data to the personnel vital signs monitoring processor, compare a round-trip-air-time from the data record of the leader unit message database with the pre-defined responder distance threshold and set a proximity flag when the round-trip-air-time is greater than or equal to the pre-defined responder distance threshold, and store the determined proximity location of the responder in the data record of the responder proximity database.

According to yet another feature the vital sign monitoring processor is further configured to receive vital signs data from the responder proximity processor, compare the received vital signs data from the responder proximity processor with the pre-defined responder vital signs threshold, set a vital signs flag when the received vital signs data is greater than or equal to the pre-defined responder vital signs threshold, and store the vital signs data record in the responder proximity database.

According to still yet another feature, the responder unit further includes a memory unit configured to store the unique electronic identifier and a ranging processor configured to process the ranging query from the leader unit and to control the transmission of the information to the leader unit, wherein the ranging radio of the responder unit is configured to communicate with the leader unit. Furthermore, the responder unit further includes a Bluetooth module configured to connect to an external vital sign sensor to acquire a status of the external vital sign sensor and to store the acquired status of the external vital sign sensor in the memory unit.

According to another feature the leader unit further includes an anchor switch configured to indicate whether the responder unit is attached to the responder.

According to another embodiment, a method of determining a proximity location of a responder is presented. The method includes receiving, at a leader unit, information including a unique electronic identifier from a responder unit attached to the responder in response to a ranging query transmitted from the leader unit, receiving, at a command post, a leader unit reporting message from the leader unit in response to a request transmitted from the command post for the leader unit reporting message, storing, at the command post, the received leader unit reporting message in a leader unit message database, determining, at the command post, the proximity location of the responder using information from at least one stored leader unit reporting message, and displaying the calculated proximity location of the responder on a map, wherein the leader unit reporting message includes the unique electronic identifier received from the responder unit, a location of the leader unit acquired from a navigation module attached to the leader unit, and round-trip-air-time data measured by determining a difference between a first time at which the ranging query was transmitted from the leader unit and a second time at which the unique electronic identifier was received at the leader unit.

According to still yet another embodiment, a leader unit configured to determine a proximity location of a responder is presented. The leader unit includes a ranging radio configured to transmit a ranging query to a responder unit attached to the responder and to receive, in response to the ranging query, a ranging response comprising a unique electronic identifier of the responder unit, a navigation module configured to acquire a position of the leader unit, a main processor configured to decode the received ranging response and to extract the unique electronic identifier, a ranging processor configured to determine a round-trip-air-time by subtracting a first time when the ranging query was transmitted from a second time when the ranging response was received, and a communication link configured to receive a leader unit message request from a command post and to transmit a leader unit reporting message in response to the received leader unit message request, wherein the leader unit reporting message includes the acquired position of the leader unit, the received unique electronic identifier of the responder unit, and the determine round-trip-air-time data.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIG. 1A illustrates a system view of an embodiment of the present invention.

FIG. 1B illustrates a communication view of an embodiment of the present invention.

FIG. 2 illustrates the architecture and configuration of a Field Unit of a Field Subsystem according to an embodiment of the present invention.

FIG. 3 illustrates a communication process between a Responder Unit and a Leader Unit of a Field Subsystem according to an embodiment of the present invention.

FIG. 4 illustrates a data record in a Leader Unit Message Database of a Command Post Subsystem according to an embodiment of the present invention.

FIGS. 5A-5C illustrate a Ranging Function and a Message Reporting Function of a Field Subsystem according to an embodiment of the present invention.

FIG. 6 illustrates a ruggedized general purpose computer for a Command Post Subsystem according to an embodiment of the present invention.

FIG. 7 illustrates a method of determining proximity location using a triangulation algorithm according to an embodiment of the present invention.

FIG. 8 illustrates a data record of a Responder Proximity Database of a Command Post Subsystem according to an embodiment of the present invention.

FIGS. 9A-9B illustrate proximity exception criteria and vital statistics exception criteria according to an embodiment of the present invention.

FIG. 9C illustrates an alert distribution according to an embodiment of the present invention.

FIG. 9D illustrates a method of alert delivery according to an embodiment of the present invention.

FIGS. 10A-10D illustrate a change in Field Unit configuration in relation to a transition of an incident operation scenario according to an embodiment of the present invention.

### DETAILED DESCRIPTION

In the following detailed description, reference is made to the accompanying drawing figures which form a part hereof, and which show by way of illustrating specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

According to one embodiment, the present invention provides an accountability proximity wireless alert system for a team of Responders. The system consists of a Command Post Subsystem and a Field Subsystem. The Field Subsystem consists of at least one Field Unit. Each Field Unit is associated with a unique electronic identifier and each Responder is equipped with a Field Unit. When attached to a Responder Group Leader, the Field Unit can be configured as a Leader Unit by the Command Post. A Leader Unit can also be anchored at a location within an incident scene, the Leader Unit anchored to a location will sometimes be referred to as an Anchored Leader Unit. Furthermore, a Command Post Subsystem is deployed at a command post.

In many configurations, a basic ranging system includes a ranging master and a ranging slave. A ranging master includes a ranging radio and a ranging processor capable of transmitting a ranging query. A ranging slave includes a ranging radio and a ranging processor capable of responding to the ranging query with ranging response. The ranging radio of the ranging master and ranging slave are preprogrammed with unique electronic identifiers.

In the Responder team operation context, each Responder carries a Field Unit including a preprogrammed ranging radio and a ranging processor configured to run as a ranging slave. The Responder Group Leader carries a Field Unit including a preprogrammed ranging radio and a ranging processor configured to run as the ranging master. A Field Unit configured to run as the ranging master will sometimes be referred to as a Leader Unit. A Field Unit configured to run as a ranging slave will sometimes be referred to as a Responder Unit. Each Field Unit further comprises a navigation module and a communication link. The configuration of a ranging processor between a ranging master and a ranging slave is initiated by the command post via a wireless communication link with the Leader Unit.

When configured as a Leader Unit, the ranging processor transmits a ranging query to each Responder Unit. The ranging processor of each queried Responder Unit transmits a ranging response including the unique electronic identifier. The ranging processor of the Leader Unit measures a round-trip-air-time from sending the ranging query to receiving the ranging response from the queried Responder Unit. The Leader Unit further includes a navigation device for determining the current location of the Leader Unit and a wireless communications link. The wireless communication may be conducted via a private wireless network or commercially available wireless technology, such as, for example, WCDMA, UMTS, 802.11, or satellite-based technology. Additionally, the navigation device may be any device which tracks the position of the Leader Unit, such as a GPS module.

Each time a Responder Unit Unique Electronic Identifier is acquired, a time-stamped message including the Leader Unit Unique Electronic Identifier, the Leader Unit's current position, the acquired Responder Unit Unique Electronic Identifier, and the round-trip-air-time is reported to the command post subsystem via the communications link.

The command post subsystem is a general purpose computer comprising a memory, a responder proximity processor, a personnel vital signs monitoring processor, a three-dimensional (3D) responder proximity map processor, and a communications link. The communications link repeatedly processes messages received from a Leader Unit and registers the messages as data records in a Leader Unit message database.

The responder proximity processor triangulates the current position of each Responder Unit by using the stored data records in the Leader Unit message database. The determined Responder Unit proximity location is registered to a data record in a responder proximity database.

The 3D responder proximity map processor creates a 3D map of the incident scene and displays the 3D map on the user interface. The 3D responder proximity map is updated via the most recent data records from the responder proximity database in order to display the most current position of each Responder. The 3D responder proximity map provides real time information regarding the proximity location of each Responder in relation to the Responder Group Leader in the 3D incident scene.

The Responder Unit attached to each Responder also comprises multi-channel Bluetooth™ module capable of acquiring data from vital sign sensors attached to the Responder. The data in the Responder Unit ID and vital signs data fields are acquired, reported, and registered in the data record of the Leader Unit message database of the command post subsystem.

When the responder proximity processor is processing a message record, the round-trip-air-time is converted to a distance measurement. An alert message is provided to the 3D responder proximity map processor and to the alert processor when the distance between the queried Responder Unit and the reporting Leader Unit exceeds a threshold. The personnel vital signs monitoring processor of the command post subsystem repeatedly analyzes the vital signs data from the records in the database to determine if the data is in accordance with respective thresholds. The personnel vital signs monitoring processor also provides an alert message to the 3D responder proximity map processor and the alert processor when an out-of-threshold vital sign data is detected.

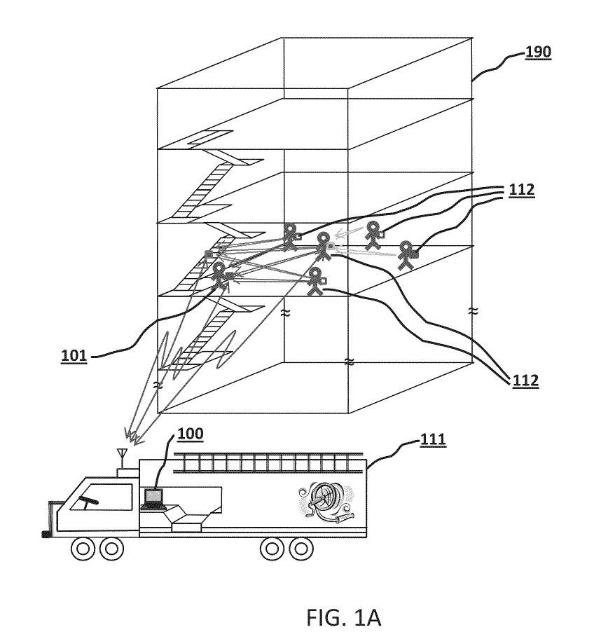

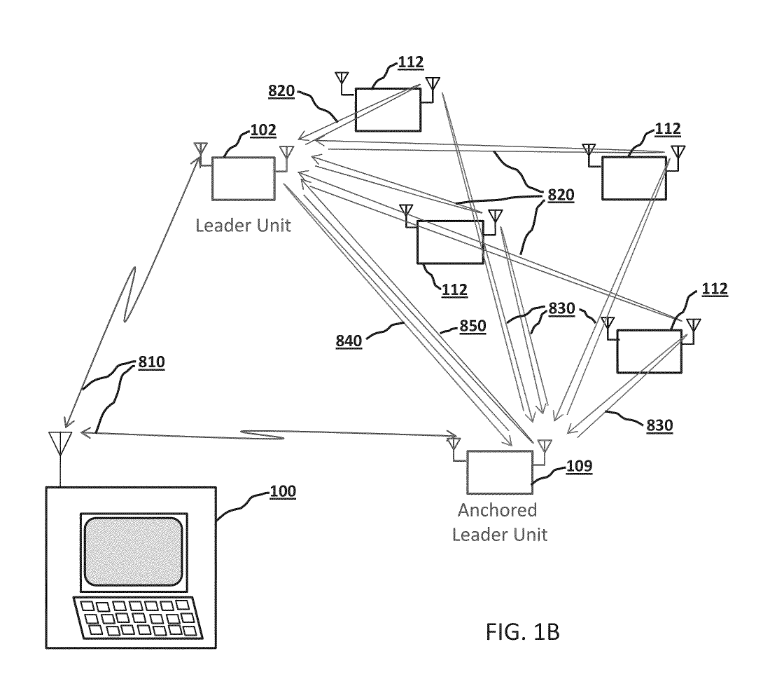

FIG. 1A illustrates a system view and FIG. 1B illustrates a communication view of the RAPAWS according to an embodiment of the present invention. As illustrated in FIG. 1A, Responders may be deployed, for example, on a 30^{TH} floor of a 70-story building 190. Each Responder may be equipped with a Responder Unit 112 and a Responder Group Leader is equipped with a Leader Unit 101. A Command Post Subsystem 100 may be deployed within a vehicle 111. The system is not limited to the single Command Post Subsystem 100, as illustrated in FIG. 1A, nor is the Command Post Subsystem 100 limited to being disposed within the vehicle 111.

As illustrated in FIG. 1B, various wireless communications signal paths may exist within the RAPAWS. For example, a first signal path 810 may be established between the Command Post 100 and each Leader Unit 101 and the Anchored Leader Unit 109. Furthermore, signal paths may be established between each Leader Unit 101 and each Responder Unit 112.

For example, a second signal path 820 may be established between the Leader Unit 101 and each Responder Unit 112. Similarly, a third signal path 830 may be established between the Anchored Leader Unit 109 and each Responder Unit 112. Moreover, a fourth signal path 840 may be established between the Leader Unit 101 and the Anchored Leader unit 109. Also, a fifth signal path 850 may be established between the Anchored Leader unit 109 and the Leader Unit 101. The second signal path 820, third signal path 830, fourth signal path 840, and fifth signal path 850 may be ranging signals.

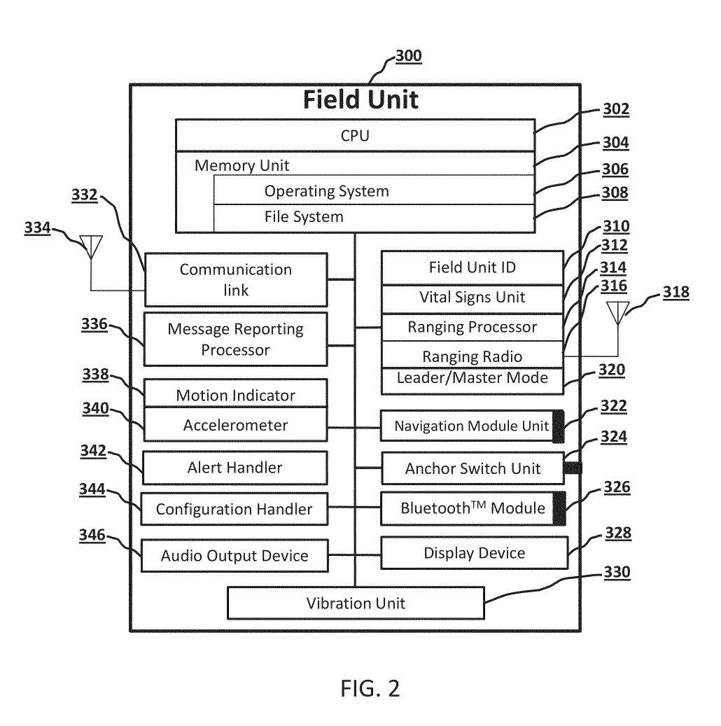

FIG. 2 illustrates a configuration of a Field Unit 300 according to an embodiment of the present invention. The Field Unit 300 may be configured as a Leader Unit or a Responder Unit. As illustrated in FIG. 2, the Field Unit 300 may include at least one central processing unit (CPU) 302, a Memory Unit 304 comprising an Operating System 306 and a File System 308, a Ranging Processor 314, a Ranging Radio 316 associated with a Field Unit ID 310 and a Vital Signs Units 312, a First Antenna 318 for the Ranging Radio 316, a Leader/Master Mode Unit 320, a Navigation Module 322, an Anchor Switch Unit 324, a Bluetooth Module 326, a Display Device 328, a Vibration Unit 330, a Communication Link 332, a Second Antenna 334 for the Communication Link 332, a Message Reporting Processor 336, a Motion Detector Unit 338, an Accelerometer 340, an Alert Handler 342, a Configuration Handler 344, an Audio Output Device 346, a Third Antenna (not shown) connected to the Navigation Module 322, and a Fourth Antenna (not shown) connected to Bluetooth module 326.

The Display Device 328 may be implemented as an LCD screen, a light source such as an LED, or any visual output device. The Field Unit ID may sometimes be referred to as a Responder Unit ID.

The Field Unit 300 may be designed of a rugged material to withstand the environmental and physical elements which are present at an incident scene, such as a fire. However, the Field Unit 300 should be lightweight and small in size such that it may be carried by a Responder without adding burden to the Responder.

The First Antenna 318, Second Antenna 334, Third Antenna, and Fourth Antenna may operate to send signals via similar or different channels. For example, the frequency and channel used for signals sent and received via the First Antenna 318 may differ from the frequency and channel used for signals sent and received via the Second Antenna 334.

The Navigation Module 322 may repeatedly receive location signals, such as a GPS signal, compute its position, and register a time-tagged position in the Memory Unit 304 for use by the Message Reporting Processor 336. The Message Reporting Processor 336 may repeatedly monitor the state of the Anchor Switch 324 and register the latest state in the Memory Unit 304. The Bluetooth Module 326 may repeatedly acquire data from external vital sign sensors via multiple Bluetooth channels and may register the acquired data in the Vital Signs Unit 312 for use by the Message Reporting processor 336. The Motion Indicator 338 may repeatedly monitor the state of the Accelerometer 340 and may register the latest state in the Memory Unit 304 for use by the Message Reporting processor 336.

The Communication Link 332 may repeatedly listen to an incoming message from the Command Post 100. The Communication Link 332 may notify the Configuration Handler 344 when it receives a configuration message from the Command Post 100. The Communication Link 332 may notify the Alert Handler 342 when it receives an alert message from the Command Post 100.

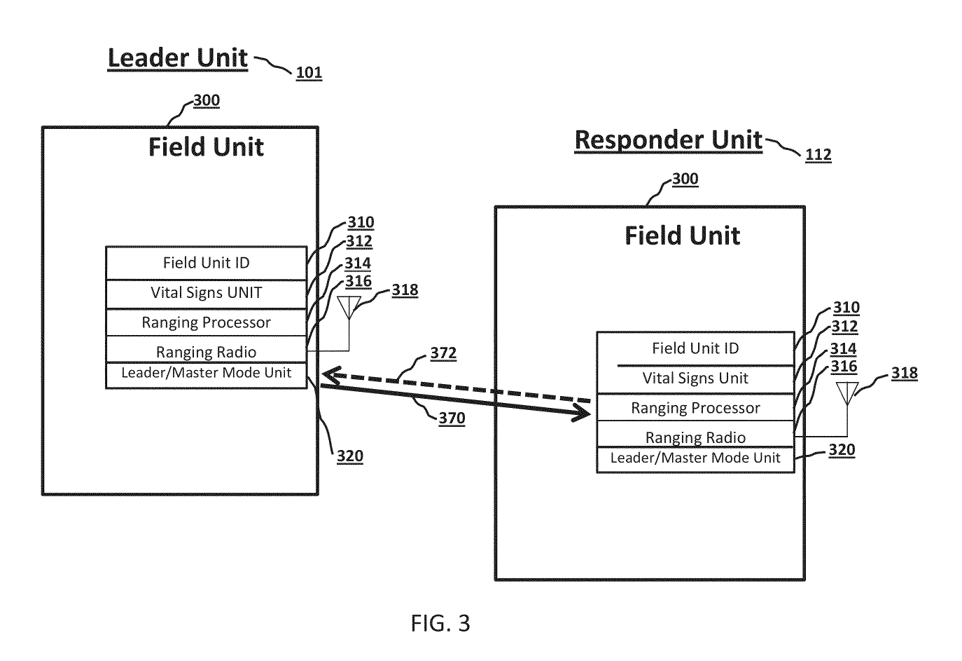

FIG. 3 illustrates a ranging function according to an embodiment of the present invention. As illustrated in FIG. 3, a Field Unit 300 is configured as a Leader Unit 101 and a Field Unit 300 is configured as a Responder Unit 112. Accordingly, the Leader/Master Mode Unit 320 of the Leader Unit 101 may control the transmission of a Ranging Query 370 to the Responder Unit 112, register a time of sending the Ranging Query 370 as a first time, wait for a response from the Responder Unit 390, receive the Ranging Response 372 from the Responder Unit 112, register a time of receiving the Ranging Response 372 as a second time, measure the Round-Trip-Air-Time by subtracting the second time from the first time, decode the received Ranging Response 372, and provide the decoded Ranging Response 372 to Ranging Processor 314.

The ranging queries 370 may be generated at predetermined time intervals in response to a signal from a Command Post Subsystem 100 or in response to a user input. The Responder Unit 112 may compile a ranging response along with its Responder Unit ID and transmit the compiled Ranging Response to the Leader Unit 101 when the Ranging Processor 314 on the Responder Unit 112 receives a ranging query 370 from the Leader Unit 101.

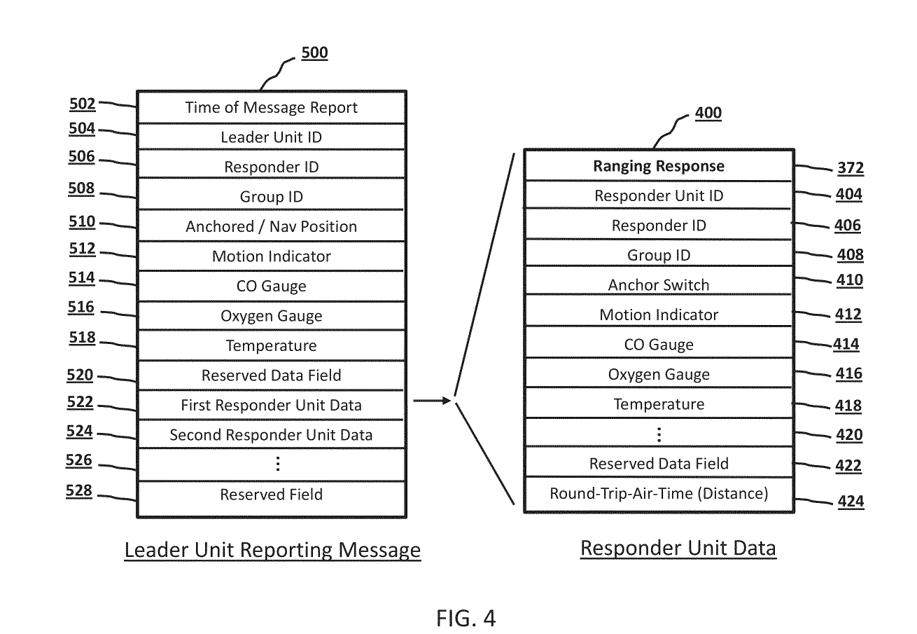

FIG. 4 illustrates Responder Unit Data 400 stored within a Responder Unit Data field such as the First Responder Unit Data 522 or the Second Responder Unit Data 524 of a Leader Unit Reporting Message 500 according to an embodiment of the present invention. As illustrated in FIG. 4, when the Ranging Processor 314 on the Responder Unit 112 (FIG. 3) compiles Ranging Response 372, the Responder Unit 390 may fill the data in the Responder Unit ID 404, Responder ID 406, Group ID 408, Anchor Switch 410, Motion Indicator 412, and the acquired vital sign sensor data such as, for example, CO Gauge 414, Oxygen Gauge 416, and Temperature 418. Furthermore, when the Leader Unit 380 has received and decoded the Ranging Response 372, the Leader/Master Mode Unit 320 of the Leader Unit 380 may fill the measured Round-Trip-Air-Time 424 to form complete Responder Unit Data 400 and provide the Responder Unit Data 400 to the Ranging Processor 314 of the Leader Unit 380. The Ranging Processor 314 provides the Responder Unit Data 400 to the Message Reporting Processor 336 when the Ranging Processor 314 receives the Responder Unit Data 400 from the Leader/Master Mode 320.

After the Message Reporting Processor 336 of the Leader Unit 380 receives the Responder Unit Data 400, the Message Reporting Processor 336 may compile a Leader Unit Reporting Message 500 by populating the fields for the Time of Message Report 502, the Leader Unit ID 504, Responder ID 506, the Group ID 508, Anchored/Nav Position 510 (if available), Motion Indicator 512, and the acquired vital sign sensor data such as, for example, CO Gauge 514, Oxygen Gauge 516, and Temperature 518. When the compilation of the Leader Unit Reporting Message 500 is completed, the Message Reporting Processor 336 may transmit the compiled Leader Unit Reporting Message 500 to the Command Post 100 via the Communication Link 332 and the Second Antenna 334 as illustrated in FIG. 2.

The Leader Unit Reporting Message 500 is not limited to First Responder Unit Data 522 and Second Responder Unit Data 524 as illustrated in FIG. 4. The Leader Unit Reporting Message 500 may include as many Responder Unit Data fields as necessary. Each Responder Unit Data 400 received by the Message Reporting Processor 336 is placed in a distinct Responder Unit Data field. The Reserved Data Field 422 of the Responder Unit Data 400, the Reserved Data Field 520 of the Leader Unit Reporting Message 500, and the Reserved Field 528 of the Leader Unit Reporting Message 500 may be reserved for future use.

Finally, the Responder Unit Data 400 is not limited to a response from a Responder Unit 112. A response to a ranging query 370 from an Anchored Leader Unit to a Leader Unit 101, and vice versa, will include a similar structure as the Responder Unit Data 400.

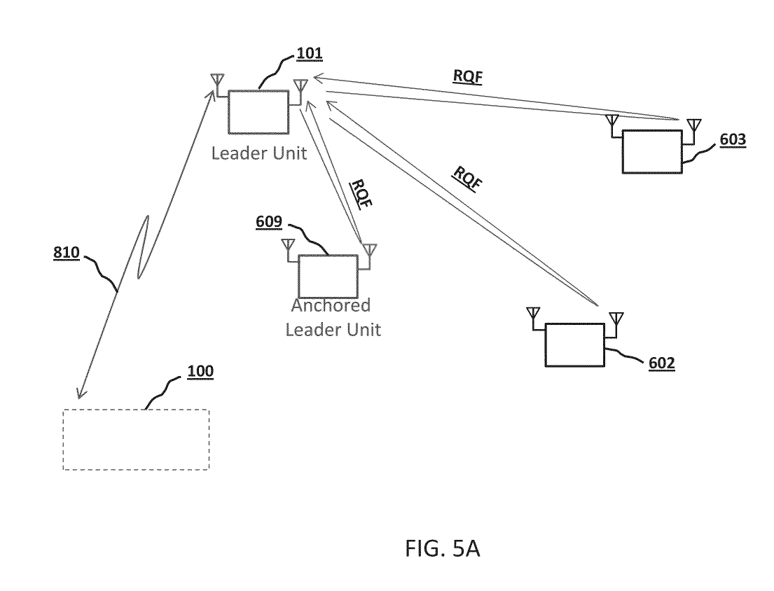

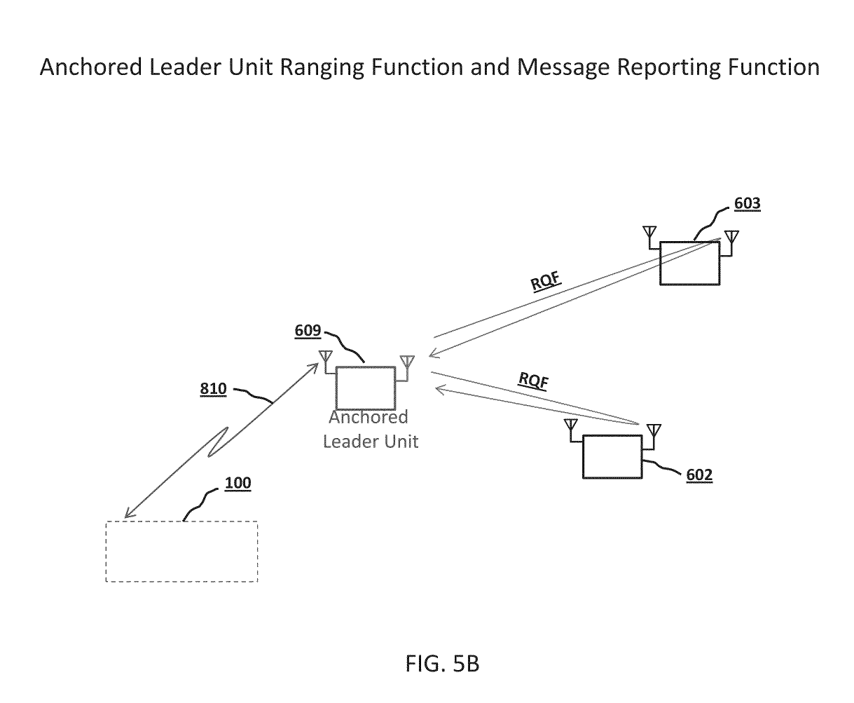

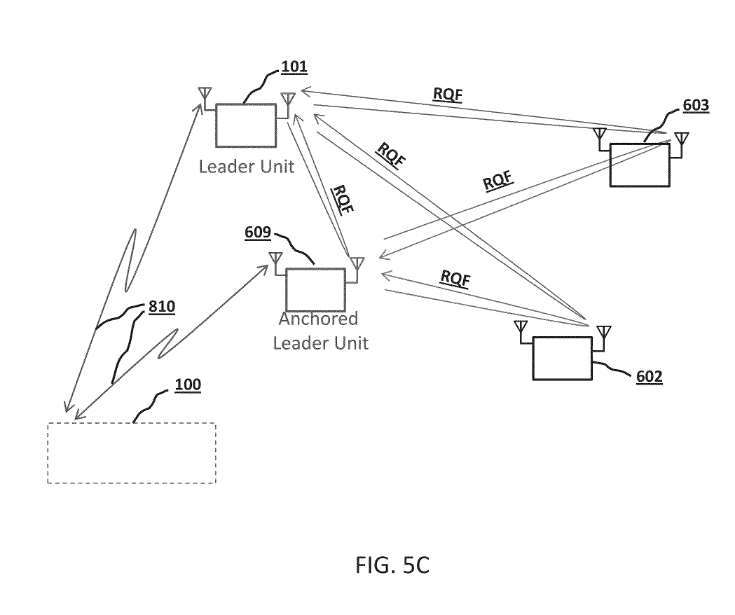

FIGS. 5A-5C illustrate the ranging function and the message reporting function according to an embodiment of the present invention. As illustrated in FIG. 5A, an incident scene may include a Leader Unit 101, an Anchored Leader Unit 609, and Responder Units 112. The Anchored Leader Unit 609 has is similar to the Leader Unit 101 illustrated in FIG. 3.

The Leader Unit 101 may perform the ranging query function (“RQF”) to measure the round-trip-air-time between the Leader Unit 101 and each Responder Unit 112, such as, for example, the First Responder Unit 602 and the Second Responder Unit 603. The Leader Unit 101 may perform the RQF to measure the round-trip-air-time between the Leader Unit 101 and any other Leader Units, such as, for example between the Leader Unit 101 and the Anchored Leader Unit 609. Furthermore, the Leader Unit 101 may acquire Responder Unit Data 400 from each of the queried Responder Units 112 and Leader Units in response to the RQF.

The Leader Unit 101 may transmit a Leader Unit Reporting Message 500 comprising the acquired Responder Unit Data 400 to the Command Post 100 via the first signal path 810. The RQF of FIGS. 5A-5C is transmitted via signal paths such as, for example, the second signal path 820, third signal path 830, fourth signal path 840, and fifth signal path 850 illustrated in FIG. 1B.

Similarly, as illustrated in FIG. 5B, the Anchored Leader Unit 609 may perform the RQF to measure the round-trip-air-time between Anchored Leader Unit 609 and each Responder Unit 112, such as, for example, the First Responder Unit 602 and the Second Responder Unit 603. Additionally, the Anchored Leader Unit 609 may perform the RQF to measure the round-trip-air-time between the Anchored Leader Unit 609 and any other Leader Units (not shown). Furthermore, the Anchored Leader Unit 609 may acquire the Responder Unit Data 400 from each of the queried Responder Units 112 and Leader Units in response to the RQF. The Anchored Leader Unit 609 may transmit the Leader Unit Reporting Message 500 to the Command Post 100 via the first signal path 810.

FIG. 5C further illustrates the RQF and message reporting function of the Leader Unit 101 in relation to the Anchored Leader Unit 609 in an overall system communication view. More specifically, FIG. 5C illustrates an embodiment of a combination of the embodiments disclosed in FIGS. 5A and 5B.

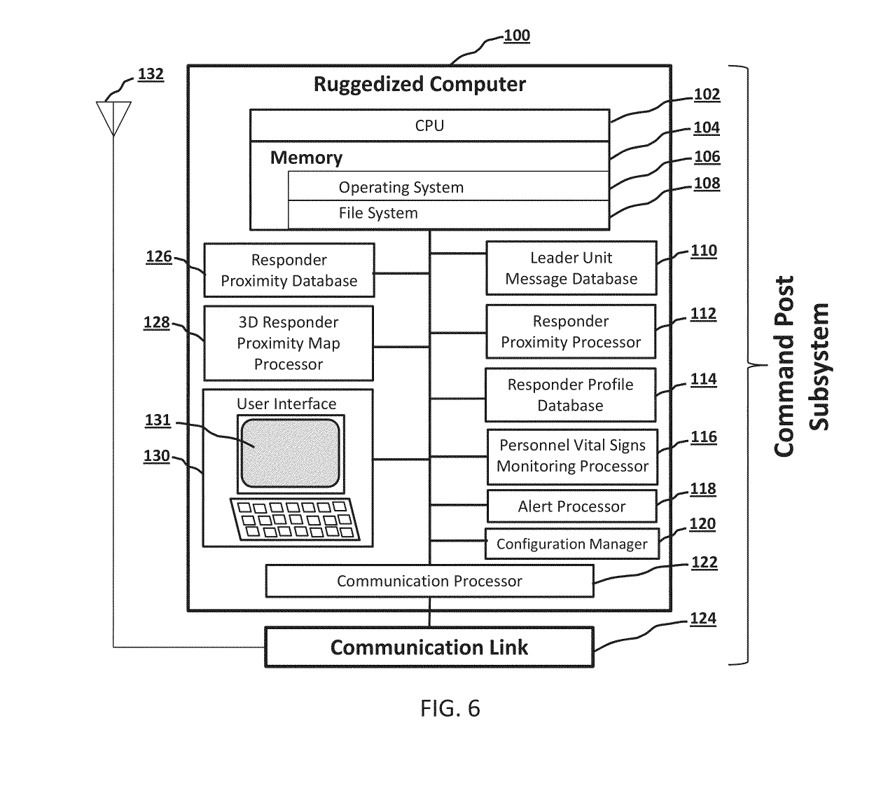

FIG. 6 illustrates a general purpose computer for a command post subsystem 100 according to an embodiment of the present invention. As illustrated in FIG. 6 the Command Post Subsystem 100 may include at least one Central Processing Unit (CPU) 102, a Memory Unit 104, a Communication Processor 122, a Responder Proximity Processor 112, a Personnel Vital Signs Monitoring Processor 116, an Alert Processor 118, a Configuration Manager 120, a 3D Responder Proximity Map Processor 128, a User Interface 130 including a display unit 131, a Communication Link 124, and an Antenna 132.

The Memory Unit 104 may store an Operating System 106, a File System 108, and databases such as a Leader Unit Message Database 110, a Responder Profile Database 114, and a Responder Proximity Database 126. As illustrated in FIG. 6, the Leader Unit Message Database 110, the Responder Profile Database 114, and the Responder Proximity Database 126 are distinct from the Memory Unit 104. However, as previously stated, the aforementioned databases may be located in the Memory Unit 104.

The Leader Unit Reporting Message 500 (FIG. 4) is an example of a data record which may be stored in the Leader Unit Message Database 110. Additionally, the Responder Proximity Database 126 may store proximity records for each Responder. The Responder Profile Database 114 may store records for each Responder Unit 112 and the associated Responder Unit ID 404 and may store additional information regarding each Responder.

During initialization of the Command Post Subsystem 100, the 3D Responder Proximity Map Processor 128 is provided with the map of the incident area, such as the blueprints of the building 190 (FIG. 1A). The map of the incident area may be pre-stored in the memory unit 104 or may be downloaded as needed via the Internet, an Intranet, or a user interface. The 3D Responder Proximity Map Processor 128 then creates a 3D Scenario Map of the given incident scenario for further use.

The Communication Processor 122 processes data received from the Leader Unit 101 and the Anchored Leader Unit 609 (FIG. 5A) via the Antenna 132 and the Communication Link 124. For example, the Communication Processor 122 receives incoming Leader Unit Reporting Messages 500 (FIG. 4) from the Leader Unit 101 (FIG. 5A) and the Anchored Leader Unit 609 (FIG. 5A) and registers the received Reporting Messages 500 in the Leader Unit Message Database 110 which may be stored in the Memory Unit 104 or in a distinct memory unit (not shown). The Communication Processor 122 receives data from the Leader Unit 101 and Anchored Leader Unit 609 in response to message requests sent from the Command Post Subsystem 100 at a predetermined interval or at the request of an operator.

Alternatively, according to another embodiment, the Leader Unit 101 and the Anchored Leader Unit 609 (FIG. 5A) may independently send data to the Command Post Subsystem 100 such that the data is not sent in response to a message request sent from the Command Post Subsystem. In this example, the Leader Unit 101 and the Anchored Leader Unit 609 may send the data to the Command Post Subsystem 100 at a predetermined interval or as the data is received from a Responder Unit 112, such as the First Responder Unit 602, for example.

The Responder Proximity Processor 112 may repeatedly query the Leader Unit Message Database 110 for new data record entries. When a new entry of Leader Unit Message Records is received, the Responder Proximity Processor 112 determines the proximity locations of the First Responder Unit 602 and the Second Responder Unit 603 (FIG. 5A) via a triangulation algorithm, and thereby determines the proximity locations of the Responders since the First Responder Unit 602 and the Second Field Responder 603 are attached to the Responders.

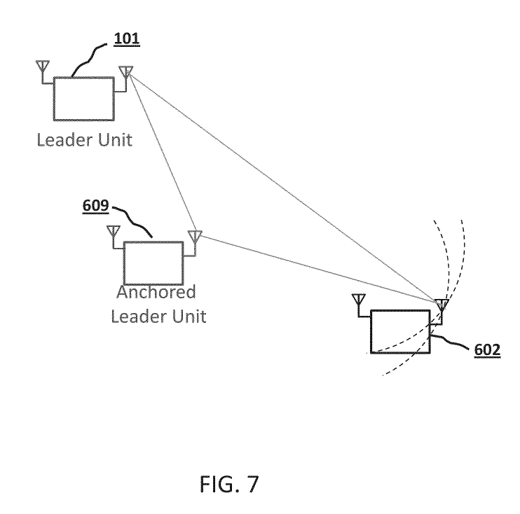

Specifically, the triangulation algorithm uses the data from the Leader Unit Reporting Message 500, such as, for example, the Round-Trip-Air-Time 424 between the Leader Unit 101 and the Anchored Leader Unit 609, the Anchored/Nav Position 510 of the Leader Unit 601, the Round-Trip-Air-Time 424 of the Responder Unit Data 400 from the First Responder Unit 602, the Anchored/Nav Position 510 of the Anchored Leader Unit 609, and the Round-Trip-Air-Time 424 of the Responder Unit Data 400 from the First Responder Unit 602, to determine the proximity location of the First Responder Unit 602 and thus the proximity location of the Responder. More specifically, the Responder Proximity Processor 112 first converts the Round-Trip-Air-Time 424 to a distance, such as feet or meters, and then executes a triangulation algorithm as illustrated in FIG. 7. While determining the proximity locations of the Responders via triangulation, the Responder Proximity Processor 112 may simultaneously determine the distance of each Responder from the Responder Group Leader, such as D-1-2 or D-9-2 (FIG. 7).

Specifically, as illustrated in FIG. 7, the triangulation algorithm may acquire three distinct distances, such as, for example, D-1-9, D-1-2, and D-9-2. As mentioned above, the Responder Proximity Processor 112 first converts the Round-Trip-Air-Time 424 to a distance, such as feet or meters. Once the distances between the Leader Unit 101 and Anchored Leader unit 609, between the Leader Unit 101 and the First Responder Unit 602, and between the Anchored Leader Unit 609 and the First Responder Unit 602 are determined, the Responder Proximity Processor 112 may determine the location of the First Responder Unit 602 via the triangulation algorithm.

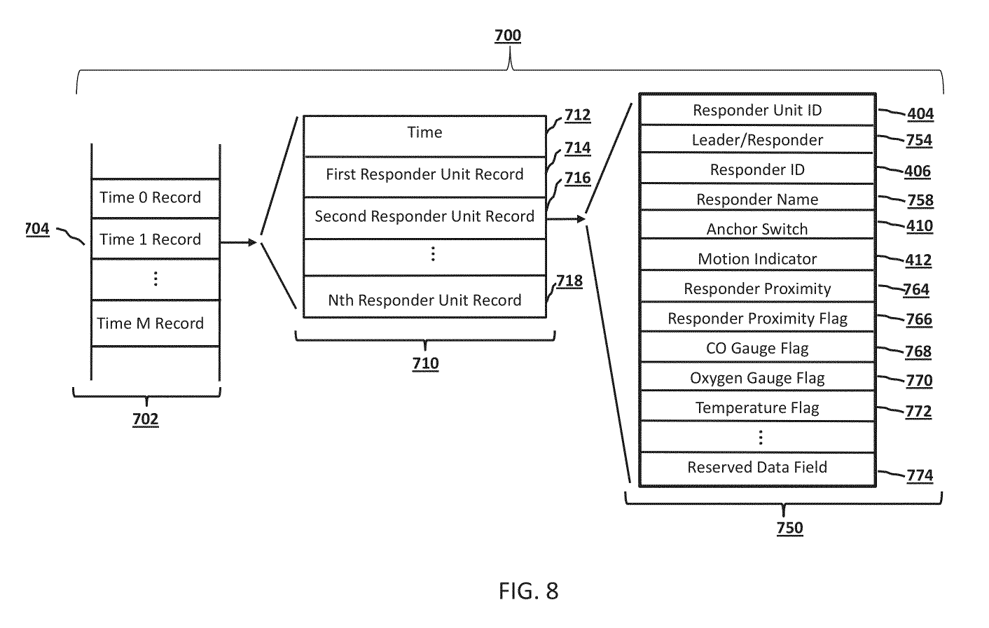

FIG. 8 illustrates an example data structure of the Responder Proximity Database 126 (FIG. 6) according to an embodiment of present invention. The data structure is a series of entries of Time Records 702. Each Time Record 702 comprises Responder Unit records for each unique Responder Unit ID 404. For example, Time 1 Record 704 includes a Time Record entry 710 stamped with Time 712 and associated with a First Responder Unit Record 714, Second Responder Unit Record 716, and N^{th} Responder Unit Record 718 each representing a Responder Unit Record 750 associated with unique Responder Unit ID 404. Each Responder Unit Record 750 comprises a unique Responder Unit ID 404, a Leader/Responder 754 indicating whether the Field Unit is a Leader Unit 101 or a Responder Unit 112, a Responder ID 406, a Responder name 758, an Anchor Switch 410, a Motion Indicator 412, a Responder Proximity 764, a Responder Proximity Flag 766, a CO Gauge Flag 768, an Oxygen Gauge 770, a Temperature Flag 772, and a Reserved Data Field 774.

When the triangulation algorithm is complete, the proximity location of the Responder is determined and the Responder Proximity Processor 112 stores the proximity location associated with the Responder Unit ID 404 in the Responder Proximity 764. Additionally, when a proximity distance of a Responder, such as the D-1-2 or D-9-2 (FIG. 7), exceeds a threshold, the Responder Proximity Flag 766 of the Responder Proximity Data Record 750 set with a value indicating an exception, such as a negative value.

The Personnel Vital Signs Monitoring Processor 116 repeatedly queries new data records from the Leader Unit Message Database 110 and compares the values of CO Gauge 414, Oxygen Gauge 416, or Temperature 418 to thresholds in the Responder Profile Database 114. When a value of the CO Gauge 414, Oxygen Gauge 416, or Temperature 418 is detected out-of-threshold, the Personnel Vital Signs Monitoring Processor 116 sets the corresponding CO Gauge Flag 768, Oxygen Gauge Flag 770, or Temperature Flag 772 with a value indicating an exception, such as a negative value.

The 3D Responder Proximity Map Processor 128 repeatedly queries Responder Proximity Records 700 from the Responder Proximity Database 126 and forwards the values of the Responder Proximity Flag 766, CO Gauge Flag 768, Oxygen Gauge Flag 770, and Temperature Flag 772 to the Alert Processor 118 (FIG. 6) for further processing. Based on each new record queried from the Responder Proximity Records 700, the 3D Responder Proximity Map Processor 128 creates a 3D Responder Proximity Map (not shown), overlays the 3D Responder Proximity Map (not shown) and the Responder Proximity Flag 766, CO Gauge Flag 768, Oxygen Gauge Flag 770, and Temperature Flag 772 with the 3D Scenario Map (not shown), and displays the 3D Responder Proximity Map on the User Interface 130.

The aforementioned fields of the databases and records, such as the Responder Proximity Database 126 and the Responder Proximity Record 700, are not limited as previously discussed. The fields of the database and records may include more or less fields as necessary.

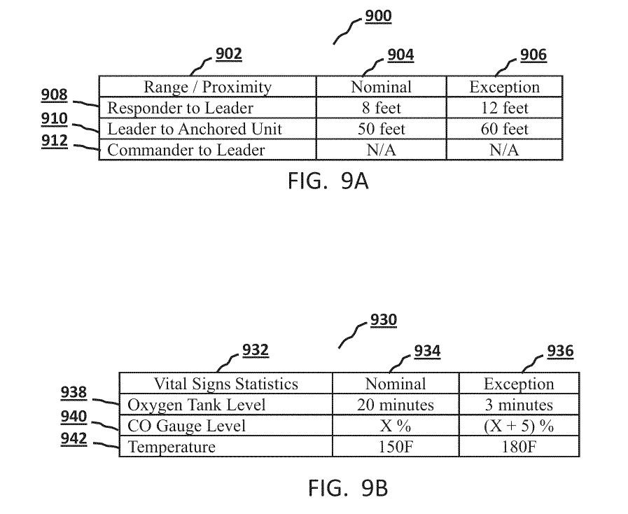

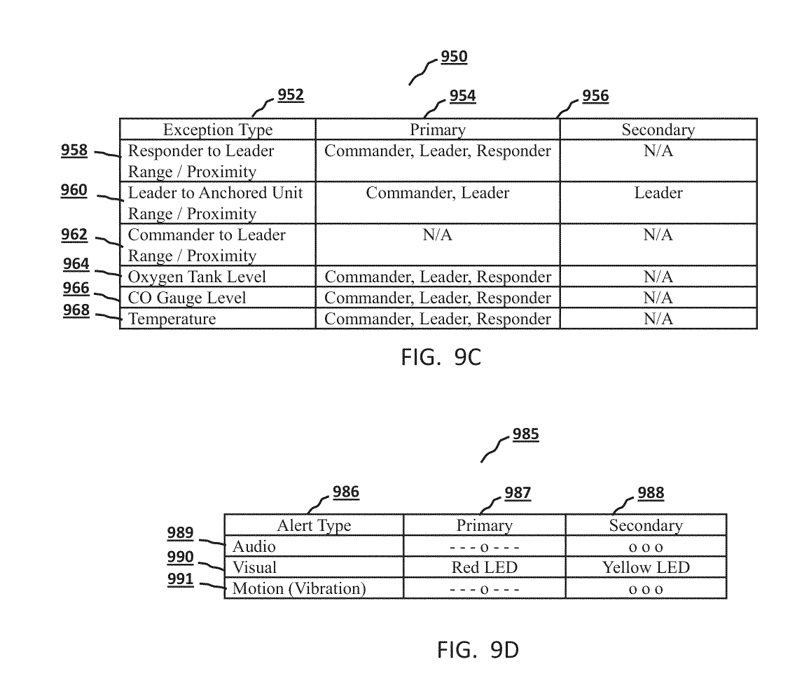

FIG. 9A and FIG. 9B illustrate examples of exceptions according to an embodiment of the present invention. FIG. 9C illustrates an example for providing alerts according to an embodiment of present invention. FIG. 9D illustrates an example of alert delivery according to an embodiment of the present invention.

FIG. 9A illustrates an example Range/Proximity Exception Criteria 900. Specifically, the Range/Proximity 902 column defines the connection from a Field Unit 300 to another unit in the RAPAWS such as, for example, from a Responder to Leader 908, from a Leader to Anchored Leader Unit 910, and from a Commander to Leader 912. The Nominal column 904 comprises nominal values for each Range/Proximity threshold during a normal incident operation, and the Exception column 906 comprises the values for each Range/Proximity threshold that are an exception during a normal incident operation. More specifically, an alert will occur when a value is greater than or equal to a value in the Exception column 906. The Range/Proximity Exception Criteria 900 may be pre-defined prior to each incident operation by an operator of the Command Post Subsystem 100.

FIG. 9B illustrates an example Vital Signs Statistics Exception Criteria 930. Specifically, the Vital Signs Statistics column 932 defines the equipment for the Vital Signs Statistics such as, for example, the Oxygen Tank Level 938, the CO Gauge Level 940, and the Temperature 942. The Nominal column 934 comprises nominal values of each Vital Signs Statistics threshold during a normal incident operation, and the Exception column 936 comprises the values for each Vital Signs Statistics definition that are an exception during a normal incident operation. More specifically, an alert will occur when a value is greater than or equal to a value in the Exception column 936. The Vital Signs Statistics Exception Criteria 930 may be pre-defined prior to each incident operation by an operator of the Command Post Subsystem 100.

FIG. 9C illustrates an example Alert Distribution 950. The Alert Type 952 column defines the Alert Type such as, for example, the Responder to Leader Range/Proximity 958, the Leader to Anchored Leader Unit Range/Proximity 960, the Commander to Leader Range/Proximity 962, Oxygen Tank Level 964, CO Gauge Level 964, and Temperature 966. The Primary column 954 comprises the destinations when sending a primary alert and the Secondary column 956 comprises the destinations when sending a secondary alert. The Alert Distribution 950 may be pre-defined prior to each incident operation by an operator of the Command Post Subsystem.

When the Alert Processor 118 receives the values of the Responder Proximity Flag 766 (FIG. 8), CO Gauge Flag 768, Oxygen Gauge Flag 770, and Temperature Flag 770 from the 3D Responder Proximity Map Processor 128, the Alert Processor 118 may send alert notifications to the pre-defined destinations according to the Alert Distribution 950.

FIG. 9D depicts examples for methods of Alert Delivery 985. The Alert Type 986 column comprises types of alerts to be delivered such as, for example, Audio 989, Visual 990, and Vibration 991. The Primary column 987 comprises the methods by which each primary alert may be delivered, and the Secondary column 988 comprises the methods by which each secondary alert may be delivered. For example, the Audio 989 and Vibration 991 fields may comprise dashes and dots to indicate the type of output, wherein a dot represents a short output burst and a dash represents a long output burst. In this example, three dots in the Secondary column 988 for the audio 989 alert represent three short audio output bursts. Furthermore, the Alert Handler 342 of the Field Unit 300 may activate the Audio Output Device 346, the Display Device 328, and the Vibration Unit 330 simultaneously to ensure the reception of alert by intended Responder. The Visual Field 990 defines the type of visual output, such as, for example a Yellow LED or a Red LED.

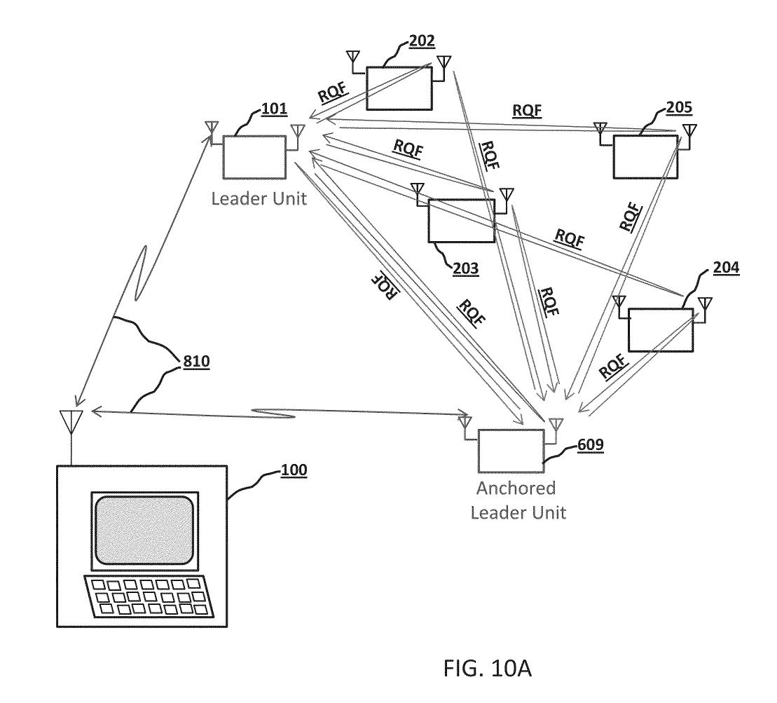

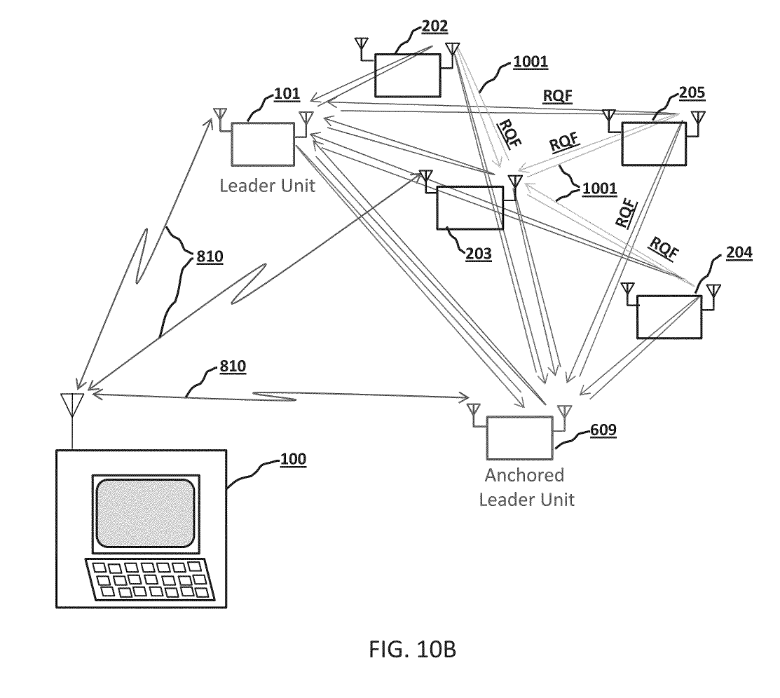

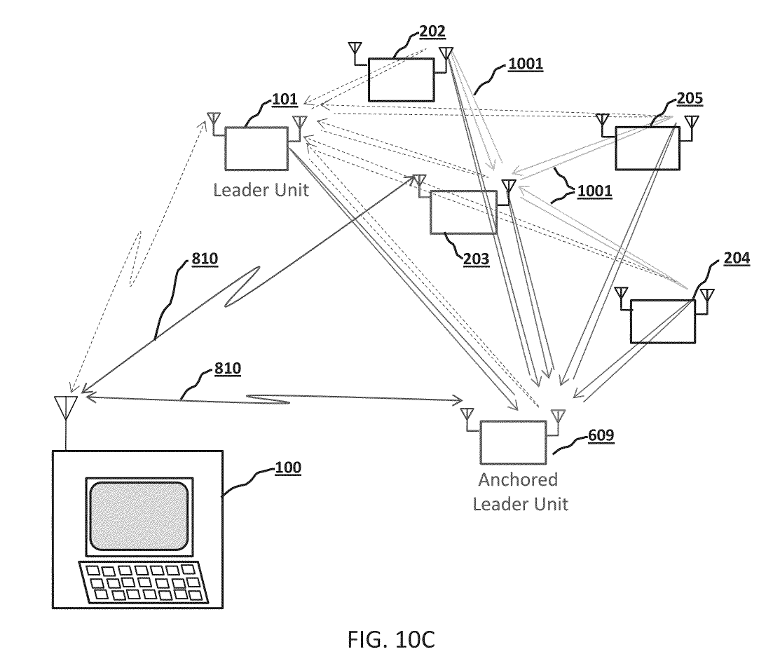

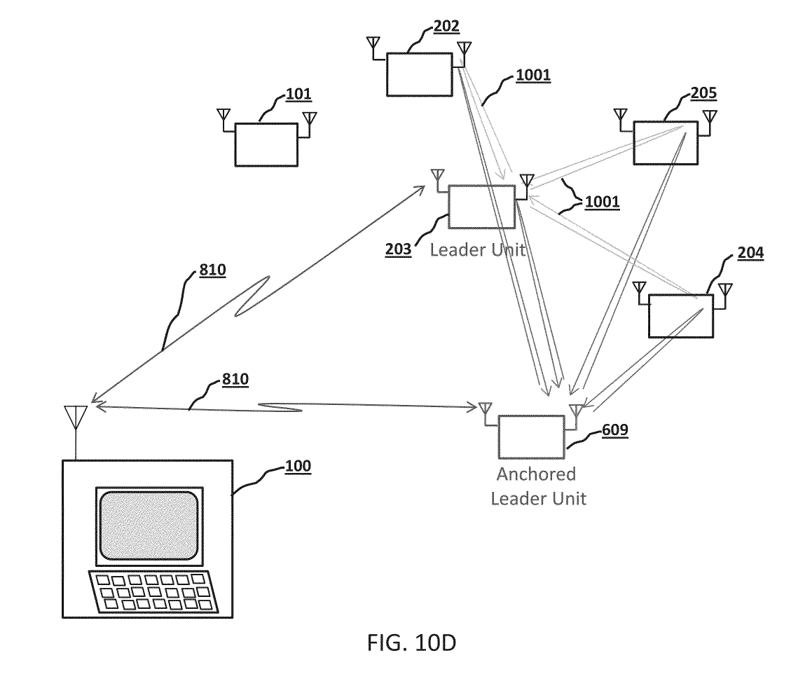

FIGS. 10A-10D illustrate examples of a transition of a Responder Unit 112 to a Leader Unit 101, from a Responder Unit to an Anchored Leader Unit, and from a Leader Unit to a Responder Unit during a normal incident operation.

During an incident operation, the Commander (not shown) may monitor the 3D Responder Proximity Map displayed on the Command Post in order to monitor the resources including Responders and Group Leaders at an incident scene. For example, FIG. 10A illustrates a layout of a Command Post, Responders, a Responder Group Leader, and an Anchored Leader Unit at an incident scene. As illustrated in FIG. 10A, Responder Units 112 are attached to three Responders and are designated as the First Responder Unit 202, the Second Responder Unit 203, the Third Responder Unit 204, and the Fourth Responder Unit 205, respectively.

During an incident, an alert may be displayed on the 3D Responder Proximity Map display and the Commander may recognize that the Responder Group Leader wearing Leader Unit 201 is in danger due to a high temperature level and a low oxygen tank level (not shown). Accordingly, the Commander would need to designate a new Responder Group Leader. The Commander may decide to designate the Responder with the Second Responder Unit 203 as the Responder Group Leader to take over the role of Responder Group Leader wearing the Leader Unit 201.

To implement the transition, the Commander may first send a request to the Configuration Manager 120 on the Command Post 100 to configure the Second Responder Unit 203 to a Leader Unit and in turn the Configuration Manager 120 may send a message to the Second Responder Unit 203 via the first signal path 810 requesting the Configuration Handler 344 to configure the Second Responder Unit 203 to a Leader Unit. The Configuration Handler 344 of the Second Responder Unit 203 activates the Leader/Master Mode and the Second Responder Unit 203 begins to perform a Ranging Function 1001 (FIG. 10B). The Ranging Function 1001 is similar to the RQF illustrated in FIGS. 5A-5C.

The Commander may then send a request to the Configuration Manager 120 on the Command Post 100 to configure the Leader Unit 201 to a Responder Unit and in turn the Configuration Manager 120 of the Command Post 100 sends a message to the Leader Unit 201 requesting the Command Handler 344 to configure the Leader Unit 201 to a Responder Unit (not shown). The Configuration Handler 344 of the Leader Unit 201 de-activates the Leader/Master Mode and the Leader Unit 201 stops performing the Ranging Function (dashed lines) as shown in FIG. 10C.

FIG. 10D illustrates the scenario of the incident operation following the configuration of the Leader Unit 201 to a Responder Unit, the configuration of the Second Responder Unit 203 to a Leader Unit, and the transition of the Ranging Function. As illustrated in FIG. 10D, the Leader Unit 201 no longer performs the RQF once it has been configured as a Responder Unit.

While the present invention has been described with reference to a few specific embodiments, the description is illustrative of the method and is not to be construed as limiting the method. Various modifications may occur to those skilled in the art without departing from the true spirit and scope of method as defined by the appended claims.

1. A wireless proximity system for responders to an emergency, the wireless proximity system comprising:
a command post comprising a command post communication link configured to transmit and receive information;
a responder unit attached to a responder and comprising a unique electronic identifier and a ranging radio, the responder unit configured to receive a ranging query and transmit information including a unique electronic identifier via the ranging radio;
a leader unit comprising:
a unique electronic identifier;
a first antenna configured to communicate with the ranging radio of the responder unit of each responder;
a second antenna configured to communicate with the command post communication link;
a navigation module for determining a current position of the leader unit; and
a ranging processor configured to control the navigation module, to control transmission of the ranging query to the responder unit, and to decode the information received from the responder unit.

2. The wireless proximity system of claim 1, wherein the leader unit further comprises:
a memory unit; and
a housing unit configured to house the ranging processor, the memory unit, the first antenna, the second antenna, and the navigation module.

3. The wireless proximity system of claim 2, wherein the leader unit further comprises:
a leader/master mode ranging processor configured determine a round-trip-air-time between the ranging query sent to the responder unit and the information received from the responder unit,
wherein the ranging processor decodes the unique electronic identifier in the information received from the responder unit; and
a message reporting processor coupled to the navigation module and the ranging processor, the message reporting processor configured to process information to be reported to the command post.

4. The wireless proximity system of claim 3, wherein:
the leader/master mode ranging processor is further configured to:
register a first navigation time from the navigation module;
send a ranging query to the ranging processor for acquiring the unique electronic identifier;
receive the unique electronic identifier from the ranging processor;
register a second navigation time from the navigation module;
measure the round-trip-air-time by subtracting the first navigation time from the second navigation time; and
provide the second navigation time, the received unique electronic identifier, and the measured round-trip-air-time to the message reporting processor; and
the message reporting processor is further configured to generate a leader unit reporting message for output via the second antenna.

5. The wireless proximity system of claim 4, wherein the leader unit reporting message comprises:
a current system time;
the unique electronic identifier of the leader unit;
a responder identification;
the current position of the leader unit;
a motion indication;
the unique electronic identifier received from the responder unit; and
the determined round-trip-air-time.

6. The wireless proximity system of claim 1, wherein the command post further comprises:
a central processing unit;
a memory unit comprising a leader unit message database and a responder proximity database;
a responder proximity processor configured to determine a proximity location of the responder unit using information from at least one data record of the leader unit message database and to store the determined proximity location of the responder unit in a responder data record associated with the responder proximity database;
a personnel vital signs monitoring processor configured to process vital sign sensor data;
a responder proximity map processor for generating a three-dimensional (3D) proximity map of the responder unit using the responder data record associated with the responder proximity database;
a user interface for displaying the 3D proximity map; and
a communication processor for controlling the receipt and transmission of information via the command post communication link.

7. The wireless proximity system of claim 6, wherein:
the leader unit message database comprises at least one data record for each message received from the leader unit via the communication link of the command post,
wherein each of the at least one data record comprises:
a time a message was reported;
the unique electronic identifier of the leader unit;
the current position of the leader unit;
the unique electronic identifier in the information received from the responder unit; and
a round-trip-air-time.

8. The wireless proximity system of claim 6, wherein the responder data record associated with the responder proximity database comprises:
a time when the responder data record was created;
the unique electronic identifier of the responder unit;
a name of the responder; and
the proximity location of the responder.

9. The wireless proximity system of claim 6, wherein the memory unit further comprises
at least a pre-defined responder distance threshold or a pre-defined responder vital signs threshold for use by the responder proximity processor.

10. The wireless proximity system of claim 9, wherein the responder proximity processor is further configured to:
query the at least one data record of the leader unit message database;
determine the proximity location of the responder by executing a triangulation algorithm;
forward the vital sign sensor data to the personnel vital signs monitoring processor;
compare a round-trip-air-time from the data record of the leader unit message database with the pre-defined responder distance threshold and set a proximity flag when the round-trip-air-time is greater than or equal to the pre-defined responder distance threshold; and
store the determined proximity location of the responder in the data record of the responder proximity database.

11. The wireless proximity system of claim 9, wherein the vital sign monitoring processor is further configured to:
receive vital signs data from the responder proximity processor;
compare the received vital signs data from the responder proximity processor with the pre-defined responder vital signs threshold;
set a vital signs flag when the received vital signs data is greater than or equal to the pre-defined responder vital signs threshold; and
store the vital signs data record in the responder proximity database.

12. The wireless proximity system of claim 1, wherein the responder unit further comprises:
a memory unit configured to store the unique electronic identifier; and
a ranging processor configured to process the ranging query from the leader unit and to control the transmission of the information to the leader unit,
wherein the ranging radio of the responder unit is configured to communicate with the leader unit.

13. The wireless proximity system of claim 12, wherein the responder unit further comprises a Bluetooth module configured to connect to an external vital sign sensor to acquire a status of the external vital sign sensor and to store the acquired status of the external vital sign sensor in the memory unit.

14. The wireless proximity system of claim 1, wherein the leader unit further comprises an anchor switch configured to indicate whether the responder unit is attached to the responder.

15. A method of determining a proximity location of a responder, the method comprising:
receiving, at a leader unit, information including a unique electronic identifier from a responder unit attached to the responder in response to a ranging query transmitted from the leader unit;
receiving, at a command post, a leader unit reporting message from the leader unit in response to a request transmitted from the command post for the leader unit reporting message;
storing, at the command post, the received leader unit reporting message in a leader unit message database;
determining, at the command post, the proximity location of the responder using information from at least one stored leader unit reporting message; and
displaying the calculated proximity location of the responder on a map,
wherein the leader unit reporting message comprises:
the unique electronic identifier received from the responder unit;
a location of the leader unit acquired from a navigation module attached to the leader unit; and
round-trip-air-time data measured by determining a difference between a first time at which the ranging query was transmitted from the leader unit and a second time at which the unique electronic identifier was received at the leader unit.

16. The method of claim 15, further comprising generating a message including the unique electronic identifier, via a ranging processor of the responder unit, in response to receiving the ranging query.

17. The method of claim 15, further comprising:
decoding the information to acquire the unique electronic identifier.

18. The method of claim 15, further comprising receiving an external vital sign status with the unique electronic identifier in response to the ranging query,
wherein the responder unit is connected to an external vital sign sensors via a Bluetooth module in order to obtain the external vital sign status.

19. A leader unit configured to determine a proximity location of a responder, the leader unit comprising:
a ranging radio configured to transmit a ranging query to a responder unit attached to the responder and to receive, in response to the ranging query, a ranging response comprising a unique electronic identifier of the responder unit;
a navigation module configured to acquire a position of the leader unit;
a main processor configured to decode the received ranging response and to extract the unique electronic identifier;
a ranging processor configured to determine a round-trip-air-time by subtracting a first time when the ranging query was transmitted from a second time when the ranging response was received; and
a communication link configured to receive a leader unit message request from a command post and to transmit a leader unit reporting message in response to the received leader unit message request,
wherein the leader unit reporting message comprises:
the acquired position of the leader unit;
the received unique electronic identifier of the responder unit; and
the determine round-trip-air-time data.

20. The leader unit of claim 19, further comprising:
a housing unit for housing the ranging radio, the navigation module, the main processor, the ranging processor, and the communication link.

21. The leader unit of claim 19, wherein the main processor is further configured to generate the ranging query.
